(19) United States
(12) Patent Application Publication
(10) Pub. No.: US 2004/0151249 A1
(43) Pub. Date: Aug. 5, 2004

(54) Method and device for video transcoding

(76) Inventor: Anthony Morel, Xi'an (CN)

Correspondence Address: Laurie Gathman, US Philips Corporation, Intellectual Property Department, P O Box 3001, Briarcliff Manor, NY, 10510, US

(21) Appl. No.: 10/479,201

(22) PCT Filed: May 27, 2002
(86) PCT No.: PCT/IB02/01873

(30) Foreign Application Priority Data
May 29, 2001 (EP) 01401405.4

(51) Int. Cl. H04N 7/12

(52) U.S. Cl. 375/240.16; 375/240.12; 375/240.2

(57) ABSTRACT

The invention relates to a scalable video transcoding method for transcoding an input video signal coded in accordance with the MPEG-2 video standard. It is an object of the invention to provide a method and device for modifying data in a coded data signal through the use of standard motion compensation processing steps used in MPEG-2 video decoders and encoders. To this end, an adding and a subtracting sub-step are inserted into the prediction loop for shifting the dynamic of the coding error so that it can be stored in a standard memory device dedicated to storing 8-bit unsigned values. Secondly, said subtracting sub-step allows to use a standard prediction step while reducing the quality drift resulting from data interpolation.

### FIELD OF THE INVENTION

The present invention relates to a method of modifying data in an input coded video signal for generating an output video signal, each video signal corresponding to a sequence of coded video frames, said method comprising at least:

an error decoding step for delivering a decoded data signal from a current input coded video frame,

a re-encoding step for delivering an output video frame, carried by said output video signal, from an intermediate data signal resulting from a first adding sub-step between a modified motion compensated signal and said decoded data signal,

a reconstruction step for delivering a primary coding error of said output video frame,

a motion-compensation step for delivering a primary motion-compensated signal from a previously stored modified coding error of a previous output video frame.

The invention also relates to a transcoding device for executing said method. This invention may be used, for example, in the field of video broadcasting or video storage.

### BACKGROUND OF THE INVENTION

Transcoding a coded data signal has become a vital function in the field of video broadcasting and personal video recording. For example, when an input video signal coded in accordance with the MPEG-2 standard has to be broadcast on a transmission channel of limited bandwidth, a transcoding method can be applied to said input video signal such that the resulting output video signal has a reduced bitrate that fits within said limited bandwidth. The same method can also be applied to personal video recorders so that the output video signal has a reduced bitrate that allows the expected recording time.

A transcoding method has been proposed in European patent application number EP 0 690 392 A1. This patent application describes a method and its corresponding device for modifying a coded data signal. In particular, this method is used for decreasing the bitrate of an input video signal coded in accordance with to the MPEG-2 standard.

### SUMMARY OF THE INVENTION

It is an object of the invention to provide a method of modifying data in a coded data signal by means of standard motion compensation processing steps used in MPEG-2 video decoders and encoders.

The prior art method is based on simplifying the cascading of a decoder and an encoder so as to reduce the number of processing steps necessary for performing a transcoding on a MPEG-2 video signal. To this end, assuming the linearity of motion compensation, the motion compensation step of the decoder and the motion compensation step of the encoder are merged, resulting in a single motion compensation step used in this prior art method.

In a video transcoding, decoding or encoding method dedicated to delivering an output video signal, motion compensation comprises mainly two processing steps:

a storing step for storing in a memory device a coding error of said output video signal: in video decoders and encoders, the storing step results in the storage in a standard memory of a coding error composed of 8-bit unsigned pixel values. Said standard memory is then characterized in that each storage elementary space receives 8-bit unsigned values.

a prediction step for calculating a predicted signal from said stored coding error: the predicted signal corresponds to the part of the signal stored in said memory device that is pointed by the motion vector relative to the part of the input video signal being processed. If such a motion vector has a half integer value, i.e. deriving from a half pixel motion estimation, linear or bilinear interpolation between values stored in said memory is performed. In video decoders and encoders, interpolation is performed in accordance with the MPEG-2 international video standard (Moving Pictures Experts Group, ISO/IEC 13818-2).

The transcoding prior art method uses a motion compensation step performed on a coding error stored in a memory, said coding error resulting from the difference between the transcoded video signal and the input video signal to be transcoded. As pixels are coded with a 8-bit dynamic for defining unsigned values between 0 and 255, the coding error has a 9-bit dynamic for defining signed values between −256 and 255. Thus a standard memory dedicated to the storing of 8-bit unsigned values, as used in decoders or encoders for storing a reference frame used in motion compensation, cannot be used. As a consequence, said memory must be specifically dimensioned for storing values defining said coding error in the implementation of the prior art transcoding method. This results in an increased memory space and difficulties in addressing such a specific memory.

In the prior art transcoding method, it can be demonstrated that the linearity assumption concerning motion compensation is not justified when half pixel motion vectors are used. It can be demonstrated that rounding is performed in the cascaded decoder/encoder, in both the decoder part and the encoder part using information that is not available anymore and than cannot be deduced in the simplified transcoder. Yet, the signed error due to incorrect rounding compared to the optimal cascade of decoder/encoder can be zero on average if the sign of the sum of the values to be interpolated is taken into account. Basically a sign-based rounding must be defined in transcoders according to the prior art for avoiding rounding errors performed in the data interpolation. However, data interpolation used in decoders and encoders, as described in the MPEG-2 video standard, do not a perform sign-based rounding on the interpolated value. As a consequence, the prediction step governing the data interpolation as defined in the MPEG-2 cannot be used in said prior art transcoding method. Indeed, if the standard prediction step is used in the prior art transcoding method, rounding errors of same sign may arise from data interpolation. Even of small amplitude, these rounding errors accumulate from frame to frame during the transcoding of a MPEG-2 video sequence, especially if many temporally predicted frames are contained in said sequence, leading to a quality drift over groups of transcoded frame, and resulting in a bad quality of the transcoded video sequence. Yet, the aim of the invention is to use the standard prediction step for the data interpolation as defined in the prior art method, which implies extra expense since a specific prediction step has to be designed. Besides, the prediction step can be shared by encoders, decoders, and transcoders. This is desirable for reducing costs and optimizing the resource allocation of integrated circuits.

To eliminate the limitations of the prior art method, the method of modifying data according to the invention is characterized in by:

a second adding sub-step for adding a first offset to said primary coding error, resulting in said modified coding error,

a subtracting sub-step for subtracting a second offset from said primary motion compensated signal, resulting in said modified motion compensated signal.

First, said adding and subtracting sub-steps allow to shift the range of said coding error so that it can be stored in a standard memory device dedicated to storing 8-bit unsigned values. Secondly, said subtracting sub-step allows to use a standard prediction step while reducing the quality drift resulting from data interpolation, provided the average rounding error due to the use of a standard prediction is included in the subtraction.

According to another characteristic of the invention, the second offset results from the addition of a fixed base offset having the value of said first offset to an additional offset having a value depending on the amplitude of horizontal and vertical components of motion vectors used in said motion compensation step.

According to another characteristic of the invention, said additional offset is set to zero if amplitudes of said horizontal and vertical components both have integer values.

According to another characteristic of the invention, said additional offset is set to a non-zero value if amplitudes of said horizontal and vertical components have non-integer values.

In this way the correction of the rounding error caused by half pixel bilinear interpolation is adapted to the interpolation type, derived from the amplitudes of motion vector components used in said motion compensation, in order to reduce the quality drift in taking into account the video sequence to be transcoded.

According to another characteristic of the invention, said second adding and subtracting sub-steps are performed in the DCT domain.

According to another characteristic of the invention, the value of said first offset is proportional to the maximum dynamic of data composing said primary coding error.

In this way said adding and subtracting sub-steps, are cost effective because they are performed in the DCT domain (Discrete Cosine Transform), i.e. in the frequency domain and because only one addition and one subtraction is performed per 8*8 block of data composing said coding error. Moreover, such a rounding correction can be easily be adapted to the DCT accuracy used. Additionally, the DCT accuracy is better than the pixel domain accuracy, which allows a finer rounding correction (less than 1 pixel-unit accuracy). It can be demonstrated that this cost-effective method outperforms the transcoding prior art. Not only is the signed error ouring to incorrect rounding compared to the optimum decoder/encoder cascade zero on average, but its variance also is lower than in the prior art transcoding.

The invention also relates to a transcoding device for modifying data in an input coded video signal for generating an output video signal by the different processing steps of the proposed method.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawing:

FIG. 1 depicts one embodiment of the transcoding method according to the invention.

### DETAILED DESCRIPTION OF THE INVENTION

The invention is well adapted to the transcoding of MPEG-2 input coded video signals, but it will be apparent to those skilled in the art that such a method is applicable to any coded signal that has been encoded by a block-based compression method such as, for example, the one described in the MPEG-1, MPEG-4, H.261, or H.263 standards.

In the following, the invention will be detailed assuming that input and output coded video signals comply with the MPEG-2 international video standard (Moving Pictures Experts Group, ISO/IEC 13818-2). It is assumed that a video frame to be transcoded is divided into adjacent squared areas of 16*16 pixels called macroblocks (MB), each MB being divided into four adjacent squared areas of 8*8 pixels called blocks (B).

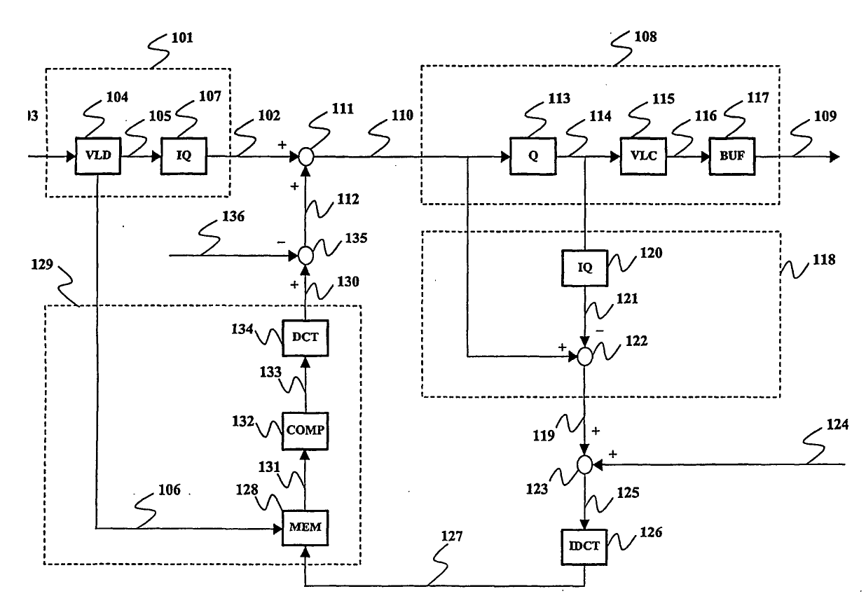

FIG. 1 depicts the general arrangement of a transcoding method according to the invention. This transcoding arrangement comprising functional steps operates as follows.

This transcoding arrangement comprises an error decoding step 101 for delivering a decoded data signal 102 from a current input coded video signal 103. This error decoding step 101 performs a partial decoding of the input video signal 103, i.e. only a reduced number of data type contained in said input signal are decoded. This step comprises a variable length decoding (VLD) 104 of at least DCT coefficients and motion vectors contained in the signal 103. This step consists in an entropy decoding, e.g. by means of an inverse look-up table of Huffman codes, allowing to obtain decoded DCT coefficients 105 and motion vectors 106. In series with said step 104, an inverse quantization (IQ) 107 is performed on said decoded coefficients 105 for delivering said decoded data signal 102. The inverse quantization 107 mainly consists in multiplying said DCT decoded coefficients 105 by a quantization factor contained in said input signal 103. In most of cases, this inverse quantization 107 is performed at the macroblock level because said quantization factor may change from one macroblock to another. The decoded signal 102 is in the frequential domain.

The transcoding arrangement also comprises a re-encoding step 108 for delivering an output video signal 109 corresponding to the signal resulting from the transcoding of said input video signal 103. The signal 109 is compliant with the MPEG-2 video standard as an input signal 103. Said re-encoding 108 acts on an intermediate data signal 110 which results from the addition, by means of the adding sub-step 111, of said decoded data signal 102 to a modified motion compensated signal 112. Said re-encoding step 108 comprises in series a quantization (Q) 113. This quantization 113 consists in dividing DCT coefficients contained in the signal 110 by a new quantization factor for delivering quantized DCT coefficients 114. This new quantization factor characterizes the modification performed by the transcoding of said input coded video signal 103, because, for example, a large quantization factor may result in a bitrate reduction of said input coded video signal 103. In series with said quantization 113, a variable length coding (VLC) 115 is applied to said coefficients 114 for obtaining entropy coded DCT coefficients 116. Similarly to VLD processing, VLC processing consists in a look-up table for assigning a Huffman code to each coefficient 114. Then coefficients 116 are accumulated in a buffer BUF 117 as well as motion vectors 106 (not depicted) for constituting transcoded frames carried by said output video signal 109.

The arrangement also comprises a reconstruction step 118 for delivering a primary coding error 119 of said output video signal 109. This reconstruction step allows to quantify the coding error introduced by the quantization 113. Such a coding error of a current transcoded video frame is taken into account, during a motion compensation step discussed in detail further below in the transcoding of the next video frame for avoiding a quality drift from frame to frame in the output video signal 109. Said primary coding error 119 is reconstructed by means of an inverse quantization (IQ) 120 performed on said signal 114, resulting in a signal 121. A subtracting sub-step 122 is then performed between signals 110 and 121, resulting in said primary coding error 119 in the DCT domain, i.e. in the frequential domain. In the adding sub-step 123 a first offset 124 is added to said primary coding error 119 for generating a modified coding error 125 in the DCT domain. Said modified coding error 125 is then passed through an inverse discrete cosine transform (IDCT) 126 for generating the modified coding error 127 in the pixel domain.

The purpose of such an adding sub-step 123 is to shift the dynamic of values composing said primary coding error 119 in a range of positive values. Indeed, in the pixel domain, since said coding error 119 corresponds to the difference between two frequential signals 110 and 121 each deriving from the DCT coding of 8-bit unsigned values (i.e. from pixels in the range 0 to 255), said coding error 119 is a frequential signal that can be considered as deriving from the DCT coding of 9-bit signed values (i.e. in the range −256 to 255). Assuming that most values composing said primary coding error 119 have small amplitudes and that they are centered around zero, a first shift is performed by adding said offset 124 to said primary coding error 119.

In FIG. 1, the addition of the offset 124 is advantageously performed in the DCT domain because a single addition of an offset 124 to the DCT coefficient corresponding to the continuous component in each 8*8 DCT block is equivalent to the addition of an offset to each of the values composing 8*8 pixel blocks. The offset 124 is fixed so as to correspond to the quarter range value of said coding error 119. If added in the DCT domain as depicted in FIG. 1, its value is furthermore proportional to the accuracy of the implemented DCT and can thus be expressed as 128*k, with k being an integer. For example k is set to 8, if the dynamic of DCT coefficients of the coding error 119 is in the range −2048 to 2047, as recommended in the MPEG-2 video standard. After being passed through the IDCT 126, the modified coding error 127 in the pixel domain is composed of pixel values in the range 0 to 255. A clipping step, consisting in forcing negative pixel values to 0 and pixel values above 255 to 255, can be applied to values generated by IDCT 126, which is not explicitly depicted in FIG. 1 because IDCT as specified in the MPEG-2 video standard implicitly contains such a clipping step.

Of course, the shift performed by the adding sub-step 123 may alternatively be performed in the pixel domain, which is not depicted in FIG. 1. Such a variant leads to the same result as in the DCT domain, although it is more expensive in terms of computation. To this end, the primary coding error 119 is first passed through the IDCT 126 for generating a coding error being composed of values in the range −256 to 255 in the pixel domain. An offset 124 set to 128, corresponding to the quarter range −256 to 255, is added to each value of said coding error in the pixel domain By means of adding sub-step 123. After addition, a clipping outside the range 0 to 255 is performed.

The modified coding error 127 is then stored in the 8-bit unsigned memory device 128, said modified coding error 127 having values comprised between 0 and 255. A standard memory device 128 can thus be used, as used in video decoders and encoders.

The arrangement also comprises a motion compensation step 129 for delivering said primary motion compensated signal 130 from a modified coding error stored in a memory MEM 128 relative to a previous transcoded video frame carried by the signal 109. The memory 128 contains at least two sub-memories: the first one dedicated to the storage of the modified coding error 127 relative to a video frame being transcoded, and the second one dedicated to the storage of the modified coding error 127 relative to a previous transcoded video frame. First, a motion compensation 132 (COMP) is done by a prediction step performed on the contents of said second sub-memory accessible via a signal 131. The prediction step consists in calculating a predicted signal 133 from said stored coding error 131: the predicted signal, also called motion compensated signal, corresponds to the part of the signal stored in said memory device 128 that is pointed by the motion vector 106 relative to the part of the input video signal 102 being transcoded. Usually, as is well known by those skilled in the art, said prediction is performed at the MB level, which means that for each input MB carried by signal 102 a predicted MB is determined and further added by the adding sub-step 111 in the DCT domain to said input MB in order to attenuate any quality drift over time. The motion compensated signal 133 being in the pixel domain, it is passed through a DCT step 134 for generating said primary motion compensated signal 130 in the DCT domain. In order to have the same dynamic for the signal 130 as for the signal 119, a shift is performed by means of the subtracting sub-step 135. To this end, a second offset 136 is subtracted from said primary motion compensated signal 130, resulting in said modified motion compensated signal 112. FIG. 1 depicts said subtracting sub-step 135 performed in the DCT domain, which offers the same advantages as those mentioned for the adding sub-step 123.

Of course, the shift performed by subtracting sub-step 135 may alternatively be performed in the pixel domain, which is not depicted in FIG. 1. Such a variant leads to the same result as in the DCT domain, but it is more expensive in terms of computation. To this end, an offset equal to one quarter of the dynamic of signal 133 (i.e. equal to 128) is subtracted from the motion compensated signal 133 by means of subtracting sub-step 135. This subtraction results in a modified motion compensated signal in the pixel domain, which is then passed through DCT 134 for generating said modified motion compensation signal 112 in the DCT domain.

In a first embodiment of the invention, the offset 136 is set in order to exactly cancel the offset addition performed by the addition sub-step 123, performed either in the DCT or the pixel domain, so that the primary coding error 119 has the same dynamic as the dynamic of the modified motion compensation signal 112. For example, if adding and subtracting sub-steps are both performed in the DCT domain, the offset 136 will have the same value as the offset 124 which is set to 128*k.

As was mentioned in the summary of the invention, it can be demonstrated that rounding errors appear in the prediction step when pixel values stored in the memory 128 are interpolated at the half-pixel level, in a motion compensation as defined in the MPEG-2 video standard in a transcoding method as depicted in FIG. 1, i.e. if motion vectors 106 computed at the half-pixel level have non-integer horizontal and/or vertical components. Said rounding error, having an amplitude of +1, can be seen as a bias that modifies the theoretical interpolated value. By using conditional probabilities, said bias is statistically evaluated in order to be corrected.

Four different types of motion vectors 106 evaluated at the half-pixel level are considered:

full_motion: motion vector having integer values for both horizontal and vertical components, e.g. (8.0, 8.0),

half_hori_motion: motion vector having half integer value for the horizontal component, and having integer value for the vertical component, e.g. (8.5, 8.0),

half_verti_motion: motion vector having integer value for the horizontal component, and having half integer value for the vertical component, e.g. (8.0, 8.5),

half_center_motion: motion vector having half integer values for both horizontal and vertical components, e.g. (8.5, 8.5),

In the following, it is considered that the probability of having one of these four types of motion vector is equal. This is represented as follows:

$$\begin{matrix}Prob ( full\_motion ) = Prob ( half\_hori \_motion ) \\ = Prob ( half\_verti \_motion ) \\ = Prob ( half\_center \_motion ) \\ = \frac{1}{4}\end{matrix} \qquad Eq . 1$$

where Prob(x) expresses the probability of having x.

The average bias, expressed in pixel units, is calcultated as follows:

$$\begin{matrix}bias = E [ error ] \\ = E [ error / “ full\_motion ” ] * Prob ( “ full\_motion ” ) + \\ E [ error / “ half\_hori \_motion ” ] * Prob ( “ half\_hori \_motion ” ] + \\ E [ error / “ half\_verti \_motion ” ] * Prob ( “ half\_verti \_motion ” ) + \\ E [ error / “ half\_center \_motion ” ] * Prob ( “ half\_center \_motion ” ) \\ = 0 * \frac{1}{4} + \frac{1}{4} * \frac{1}{4} + \frac{1}{4} * \frac{1}{4} + ( 3 - 1 ) / 16 * \frac{1}{4} \\ = 5 / 32 pixel unit\end{matrix} \qquad Eq . 2$$

where error is the overall motion-compensation result given by “the optimal cascade of decoder and encoder” minus the motion compensation result given by “simplified transcoder using standard motion compensation”

E[error] expresses the error expectation (or the bias),

E[error/“x”] expresses the error expectation while having x.

An attempt according to the invention to make the transcoder with standard motion compensation drift-free constitutes a removal of the bias estimated according to Eq.2 and caused by rounding errors. This can be realized by subtracting said bias from said signal 133 in the pixel domain, or from said primary motion compensated signal 130 in the DCT domain. A separate subtracting sub-step (not depicted in FIG. 1) may be used for this. However, the subtracting sub-step 135 is advantageously re-used, because the bias can be seen as an additional offset to be subtracted from the signal 130. This is also advantageously done in the DCT domain because the dynamic of a DCT signal is greater than the dynamic of a pixel signal, so that a fraction of the pixel value is more easily subtracted. Thus the value of the offset 136 is set such that it corresponds to the addition of said offset 124 (called base offset) to said bias value. The value of the offset 136 is then set as follows:

$$\begin{matrix}offset\_ 136 = Round ( offset\_ 124 + bias ) \\ = Round ( 128 + bias ) * k \\ = Round ( 128 + 5 / 32 ) * k\end{matrix} \qquad Eq . 3$$

where Round(x) rounds x to the nearest integer.

For example, if the DCT accuracy is chosen so that k=8, the offset 136 is set to 1025 after rounding according to Eq.3.

Subtracting said bias, from the signal 130 by means of subtracting sub-step 135, means that a standard prediction step as used in decoders or encoders can be used for half-pixel interpolation, while strongly reducing the rounding error. This results in a cost-effective solution because it requires a simple subtraction of the offset 136 from the signal 130, but also because standard motion compensation steps (MEM+COMP) of decoders and encoders are reused or shared. This method avoids a quality drift on transcoded frames, which can be quantified as an increase in the PSNR (Peak Signal to Noise Ratio), and a smaller bits consumption on predicted frames compared to the drifty-prone method.

A refinement of the bias removal is proposed below which takes into account the type of the motion vector 106, for ensuring that the bias is removed only when this is considered necessary. For example, if only full-pixel motion compensation is used in the input data, then there is no bias to remove, as there is no error. Note: in the previous computation, the different types of motion vectors were considered to have the same probability of occurrence. Horizontal and vertical components of motion vectors 106 are considered, referenced motion_x and motion_y, respectively.

It is conventionally assumed that, if a horizontal and/or a vertical component have odd values, the amplitude of the motion vector 106 along this axis has a non-zero half-pixel decimal. This concerns motion vector types corresponding to half_hori_motion, half_verti_motion and half_center_motion as defined above. In this case, a data interpolation between data stored in memory 128 is performed during the prediction step, which is subject to bias correction. Otherwise, horizontal and vertical components of the motion vector 106 are expressed as an integer value. This applies to motion vector types corresponding to full_motion as defined above. In this last case, no data interpolation is performed during the prediction step, so that no bias correction is needed.

The first strategy for determining whether a bias correction is needed consists in testing the parity of both motion_x and motion_y. If at least one of these component is odd, a bias correction is performed (i.e. bias≠0), otherwise, no bias correction is performed (i.e. bias=0).

This can be expressed by the following algorithm which gives the value of the offset 136, said offset 136 resulting from the addition of said base offset to said additional offset:

if(odd(motion_{—}x) or odd(motion_{—}y)) offset_{—}136=(128+E[error/“half_motion”])*k

else

offset_{—}136=128*k

with

$$\begin{matrix}E [ error / “ half\_motion ” ] = + E [ error / “ half\_hori \_motion ” ] * \\ Prob ( “ half\_hori \_motion ” ) + \\ E [ error / “ half\_verti \_motion ” ] * \\ Prob ( “ half\_verti \_motion ” ) + \\ E [ error / “ half\_center \_motion ” ] * \\ Prob ( “ half\_center \_motion ” ) \\ = \frac{1}{4} * 1 / 3 + \frac{1}{4} * 1 / 3 + ( 3 - 1 ) / 16 * 1 / 3 \\ = 5 / 24 pixel unit\end{matrix} \qquad Eq . 4$$

For example, if the DCT accuracy is chosen so that k=8, the algorithm is such that:

if(odd(motion_{—}x) or odd(motion_{—}y)) offset=1025

else

offset=1024

In this first strategy, a half pixel motion vector is advantageously detected in performing an exclusive OR between the least significant bits of motion_x and motion_y, if this boolean operation results in 1.

The second strategy consists in performing a bias correction whose value depends on the type of motion vector 106 among fill_motion, half_hori_motion, half_verti_motion, half_center_motion as defined above. A bias correction is performed for the first three types of motion vector, while this bias is set to zero if the motion vector has integer horizontal and vertical components. This can be summarized in the following algorithm:

if(odd(motion _{—}x)) if(odd(motion_{—}y)) offset_{—}136=(128+E[error/“half_center_motion”])*k

else

offset_{—}136=(128+E[error/“half_hori_motion”])*k

else

if(odd(motion _{—}y)) offset_{—}136=(128+E[error/“half_verti_motion”])*k

else

offset_{—}136=128*k

For example, if the DCT accuracy is chosen so that k=8, the algorithm is such that:

if(odd(vector_{—}x)) if(odd(vector_{—}y)) offset_{—}136=1025

else

offset_{—}136=1026

else

if(odd(vector_{—}y)) offset_{—}136=1026

else

offset_{—}136=1024

A third strategy relates to field-based images to be transcoded, composed of two separate fields. This type of image comprising two motion vector fields, a motion compensation has to be performed successively for each separate field. The second strategy can thus be used to this end for each field to be motion compensated.

In the proposed invention, the subtracting sub-step 135 may be replaced by an adding sub-step resulting in the same modified motion compensated signal 112. In this case, a negative offset whose absolute value is that of the offset 136 described above is added to said primary motion compensated signal 130.

This invention may also be used if the prediction step implies an interpolation at the quarter-pixel level of data contained in the memory 128, i.e. with motion vectors 106 whose horizontal and vertical components have been calculated with quarter-pixel accuracy. In this context, the error expectation resulting from an interpolation performed between data values stored in the memory 128 is calculated by means of conditional probability, similarly as in Eq.2, then subtracted from said signal 130.

In the proposed invention as described above, the additional offset is set to a zero value if the amplitude of horizontal and vertical components of the motion vector 106 have integer values, but it may also be set to zero if no drift correction is desired.

The proposed invention demonstrably outperforms the prior art transcoder, though its aim was cost reduction through re-use or sharing of motion compensation. Indeed, the variance of the error caused by incorrect rounding compared to the optimum cascade of decoder/encoder is lower than in the prior art transcoding.

This method is particularly dedicated to the transcoding of video sequences encoded in accordance with the MPEG standards family, such as the MPEG-2 standard. The method can thus be implemented in any video transcoding devices used in bitrate data reduction applications, video streaming, or broadcasting, but also for video storage applications.

This method may be implemented, for example, by means of wired electronic circuits or, alternatively, by means of a set of instructions stored in a computer-readable medium, said instructions replacing at least a portion of said circuits and being executable under the control of a computer or a digital processor in order to carry out the same functions as fulfilled in said replaced circuits. The invention then also relates to a computer-readable medium comprising a software module which includes computer executable instructions for performing the steps, or some steps, of the method described above. In particular, a memory dedicated to the storage of 8-bit unsigned values will be used for the memory device 128.

1. A method of modifying data in an input coded video signal for generating an output video signal, each video signal corresponding to a sequence of coded video frames, said method comprising at least:
an error decoding step for delivering a decoded data signal from a current input coded video frame,
a re-encoding step for delivering an output video frame, carried by said output video signal, from an intermediate data signal resulting from a first adding sub-step between a modified motion compensated signal and said decoded data signal,
a reconstruction step for delivering a primary coding error of said output video frame,
a motion-compensation step for delivering a primary motion-compensated signal from a previously stored modified coding error of a previous output video frame,
characterized in that said method comprises:
a second adding sub-step for adding a first offset to said primary coding error, resulting in said modified coding error,
a subtracting sub-step for subtracting a second offset from said primary motion compensated signal, resulting in said modified motion compensated signal.

2. A method of modifying data as claimed in claim 1, characterized in that the second offset results from the addition of a fixed base offset having the value of said first offset to an additional offset having a value depending on the amplitude of horizontal and vertical components of motion vectors used in said motion compensation step.

3. A method of modifying data as claimed in claim 2, characterized in that said additional offset is set to zero if amplitudes of said horizontal and vertical components both have integer values.

4. A method of modifying data as claimed in claim 3, characterized in that said additional offset is set to a non-zero value if amplitudes of said horizontal and vertical components have non-integer values.

5. A method of modifying data as claimed in claim 4, characterized in that said second adding and subtracting sub-steps are performed in the DCT domain.

6. A method of modifying data as claimed in claim 5, characterized in that the value of said first offset is proportional to the maximum dynamic of data composing said primary coding error.

7. A transcoding device for modifying data in an input coded video signal for generating an output video signal, each video signal corresponding to a sequence of coded video frames, said transcoding device comprising at least:
error decoding means for delivering a decoded data signal from a current input coded video frame,
re-encoding means for delivering an output video frame, carried by said output video signal, from an intermediate data signal resulting from a first adding means between a modified motion compensated signal and said decoded data signal,
reconstruction means for delivering a primary coding error of said output video frame,
motion-compensation means for delivering a primary motion-compensated signal from a previously stored modified coding error of a previous output video frame,
characterized in that said device comprises:
second adding means for adding a first offset to said primary coding error, resulting in said modified coding error,
subtracting means for-subtracting a second offset from said primary motion compensated signal, resulting in said modified motion compensated signal.

8. A transcoding device as claimed in claim 7, characterized in that the second offset results from the addition of a fixed base offset having the value of said first offset to an additional offset having a value depending on the amplitude of horizontal and vertical components of motion vectors used by said motion compensation means.

9. A transcoding device as claimed in claim 8, characterized in that said additional offset is set to zero if amplitudes of said horizontal and vertical components both have integer values, and in that said additional offset is set to a non-zero value if amplitudes of said horizontal and vertical components have non-integer values.

10. A computer program product for a transcoding device for modifying data in a coded video signal, which product comprises a set of instructions which, when loaded into said device, causes said device to execute any processing steps as claimed in claims 1 to 6.
